(19) United States
(12) Patent Application Publication
(10) Pub. No.: US 2025/0319963 A1
(43) Pub. Date: Oct. 16, 2025

(54) Emergency Autoland Braking System

(71) Applicant: Textron Aviation Inc., Wichita, KS (US)

(72) Inventors: Michael Troy Heeren, Wichita, KS (US); Bryan Akira Ensor, Wichita, KS (US); Timothy Magruder, Norwich, KS (US)

(21) Appl. No.: 18/636,168

(22) Filed: Apr. 15, 2024

(51) Int. Cl. B64C 25/48

(52) U.S. Cl. CPC B64C 25/48

(57) ABSTRACT

Emergency autoland systems for aircraft must be able to apply braking to the landing gear wheels on an aircraft during landing. The present disclosure details an emergency autoland braking system and associated apparatus for aircraft. Separate from a pedal brake or a toe brake system that requires input from a pilot or copilot, the aircraft is equipped with a second braking system powered by an actuator that can pull on aircraft brake cables independently of the pedal brakes while still allowing for input from the brake pedals. The actuator may be commanded by the emergency autoland system on board the aircraft. The system provides an equal displacement to both brake cables and is calibrated to slow down the aircraft uniformly.

### BACKGROUND

### 1. Field

The disclosed embodiments relate generally to the field of autonomous vehicle control. More specifically, the disclosed embodiments are related to automatic braking for emergency autoland systems in aircraft.

### 2. Related Art

Emergency autoland braking systems for aircraft have been described in the past. They generally use actuators acting directly on additional hydraulic master cylinders in the braking system. U.S. Pat. No. 10,442,529 to Dupre et al. discloses a system for controlling a lateral trajectory of an aircraft and includes actuators connected to the rudder pedals; however, the actuators described are used for providing haptic feedback to the pilot. U.S. Pat. No. 9,227,608 to Hill et al. discloses a decentralized electric brake system, known as brake-by-wire, and includes electric actuators used to actuate the mechanical braking system at the aircraft brake assembly. U.S. Pat. No. 9,656,641 to Griffith et al. discloses an aircraft electrical brake control system, known as brake-by-wire, and includes electric actuators used to actuate the mechanical braking system at the aircraft brake assembly.

### SUMMARY

In embodiments of the present disclosure, an aircraft braking system, includes a left brake cable operatively coupled to a braking mechanism and a left rudder pedal; a right brake cable operatively coupled to the braking mechanism and a right rudder pedal; a slider configured on a slide and mechanically coupled to the left brake cable and the right brake cable, wherein the slider is configured to displace the left and right brake cables when the slider is moved; and an actuator configured to displace the slider thereby activating the left and right braking mechanisms, respectively, wherein the actuator and the slider operate independently of the left and right rudder pedals.

In embodiments of the present disclosure, an emergency autoland braking system for aircraft includes: a pair of braking mechanisms; a pair of brake cables operatively coupled to the pair of braking mechanisms, respectively; a first braking subsystem configured to pull the pair of brake cables for activating the pair of braking mechanisms; and a second braking subsystem configured to pull the pair of brake cables for activating the pair of braking mechanisms, wherein the first and second braking subsystems operate independently of one another, and wherein the second braking system pulls the brake cables between the first braking subsystem and the pair of braking mechanisms.

In embodiments of the present disclosure, an emergency autoland braking system includes: an actuator configured to displace a left and right brake cable when the actuator is driven, wherein displacement of the brake cables engages a set of aircraft brakes; a calibration mechanism configured to adjust a magnitude of displacement of each brake cable when the actuator is driven; and a control system configured to engage the actuator such that the set of aircraft brakes is engaged based on instructions provided by the control system.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1 is a perspective view of an aircraft braking system with an emergency autoland braking subsystem, in an embodiment;

FIG. 2 is a close-up view showing portions of FIG. 1;

FIG. 3A is a perspective view of an emergency autoland braking subsystem with a single actuator and an equal displacement mechanism positioned downstream of the brake rudder pedals, in an embodiment;

FIG. 3B is a view of the emergency autoland braking system of FIG. 3A;

FIG. 4 is a cross-sectional view of a portion of the equal displacement mechanism shown in FIG. 3A;

FIG. 5A is a view of the autoland braking system of FIG. 3A in a rest position with a maximum force applied by an upstream braking system; and

FIG. 5B is a view of the autoland braking system of FIG. 3A in an engaged position.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments, but is not necessarily included. Thus, the technology can include a variety of combinations and/or integrations of the embodiments described herein.

Emergency autoland systems in some high-performance aircraft use automatic braking during the landing phase to stop the aircraft on the runway. For aircraft that do not have brake-by-wire systems, a mechanical input is required to engage wheel braking mechanisms (e.g., brake metering valves or master cylinders). When the system design is used on multiple aircraft, in which the different aircraft have different design aspects, actuating the rudder pedals using one actuator minimizes differences in design. Limiting the number of actuators may also be advantageous in reducing the system's complexity.

Where differential braking is not required, a single actuator may be used with a rigging calibration mechanism that may be configured to apply equal braking pressure to the left and right brake wheels. In such an embodiment, a pair of brake cables may be equally displaced by components of the rigging calibration mechanism. The command to the actuator from the emergency autoland system may be a simple discrete signal or a proportional command signal, based on the needs of the aircraft.

Embodiments disclosed herein use one mechanical actuator to physically engage the brake metering valve on aircraft that are equipped with electrohydraulic brake systems. The actuator engages wheel brakes downstream of the rudder pedals to provide braking in the same manner as the pilot (i.e., by pressing down on the top of the rudder pedals via “toe brakes” to activate wheel braking mechanisms). Where no differential braking is required, a brake pressure equalization means is provided so that a single actuator provides equal braking to the left and right wheels. A control system may send a signal to the actuator to engage the braking mechanism but does not interfere with the normal pilot usage when the actuator is unused. The control system can be configured with instructions (such as software) to send a simple discrete signal to the actuator if an anti-skid mechanism is implemented on the aircraft brakes, or the control system can send a signal configured to operate the actuator at a constant speed, or the control system may send another type of signal to engage the actuator. The nature of the signal may be informed by data from aircraft avionics in embodiments. The disclosed embodiments allow for any electromechanical actuators or servos required for the braking system to be installed in more spacious areas of the aircraft and also require less input force than direct brake pedal actuation methods.

Embodiments disclosed herein utilize a servo motor or electromechanical actuator (EMA) to apply force to the aircraft braking mechanism (e.g., the brake metering valve). This force may be applied to the braking mechanism directly via input levers or indirectly via input sectors or cables. An example of the force being applied directly via input levers is described in U.S. Provisional Patent Application No. 63/625,335 entitled Emergency Autoland Braking System and filed on Jan. 26, 2024, the disclosure of which is hereby incorporated by reference in its entirety. In the present application, the force is applied indirectly via input sectors or cables as further described below. Whether the force is applied to the braking mechanism inputs directly or indirectly, a centering mechanism is attached to the single actuator and used to equalize the force applied to the left and right inputs. Electrical power is applied to the servo or EMA such that the actuator may be engaged at full speed or at a controlled speed. The actuator engages the braking mechanism inputs sufficiently to provide the required braking up to a maximum braking force with anti-skid engagement.

Embodiments disclosed herein may be operated open loop or closed loop based on the specific implementation. For example, open loop operation may apply maximum braking force to intentionally engage an anti-skid system, allowing the anti-skid system to fully decelerate and stop the aircraft. One example of closed loop operation may be a system that applies a proportional braking force based on input from various sensors on the aircraft, including sensors for wheel speed, longitudinal acceleration, airspeed, altitude, etc. Based on feedback from one or more sensors, a braking force may be applied that slows the aircraft as quickly and safely as possible without skidding the tires. The system may also be implemented using any other method of mechanical force/torque transmission to the brake pedals, such as pushrods.

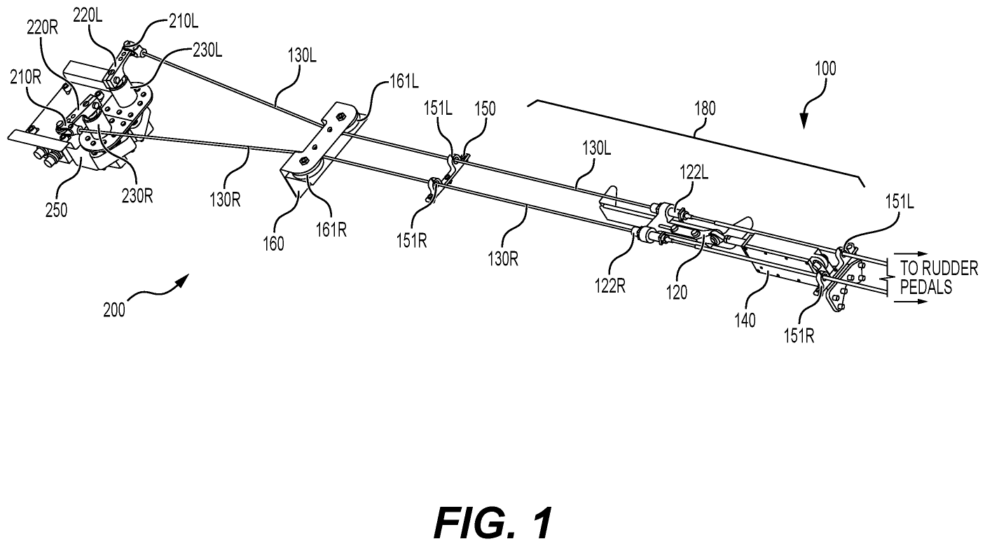

Referring now to FIG. 1, an autoland braking system 100 is configured as a subsystem of a braking system 200, in an embodiment. An aircraft 110 comprises braking system 200 to operate brakes on aircraft 110; however, aircraft 110 is not shown in FIG. 1 so that the features of braking system 200 may be more clearly demonstrated. Autoland braking system 100 and rudder pedals (not shown) are subsystems of braking system 200 configured to engage any brakes mechanically coupled to braking system 200. Autoland braking system 100 and the rudder pedals may engage the brakes independently while either subsystem is currently engaging the brakes.

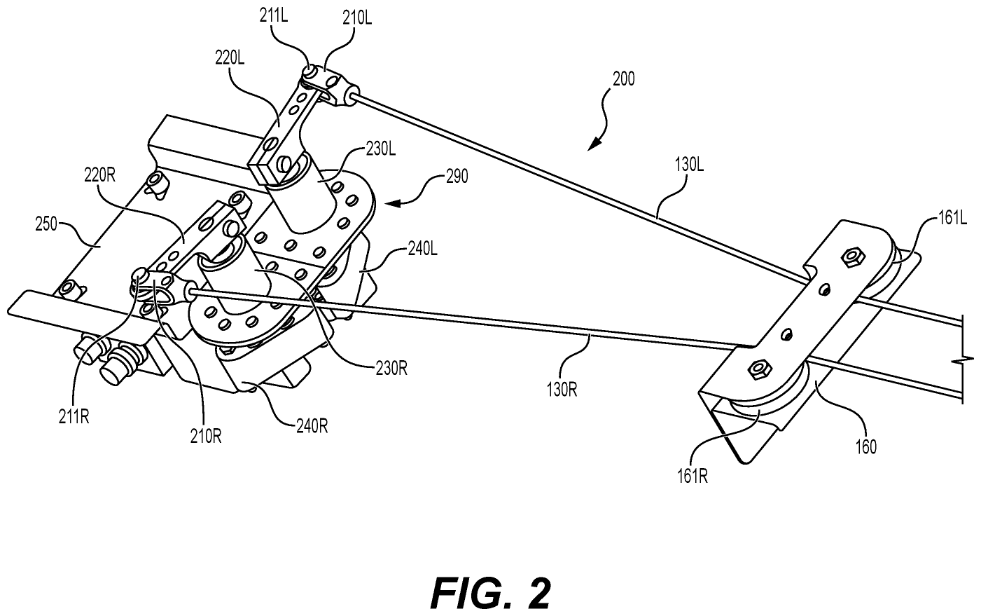

Braking system 200 comprises at least braking mechanism 250 and brake cables 130L, 130R. “Upstream” indicates a direction toward the brake rudder pedals while “downstream” indicates a direction towards braking mechanism 250. Brake cables 130L, 130R are a set of left and right brake cables operatively coupled to the pilot and copilot rudder pedals upstream (not shown) and braking mechanism 250 downstream. Brake cables 130L, 130R are held under tension between the rudder pedals and brake mechanism 250. When a force pulls brake cables 130L, 130R upstream, brake cables 130L, 130R transmit that force to brake mechanism 250. For instance, a depression of the rudder pedals imparts an upstream force on brake cables 130L, 130R, thereby engaging brake mechanism 250 (via the mechanical linkage described in FIG. 2). When brake mechanism 250 is engaged, aircraft brakes of aircraft 110 apply a braking force.

When no upstream force is applied, braking system 200 is in a rest position. In the rest position, brake cables 130L, 130R remain under tension but do not engage braking mechanism 250. Tie members 210L, 210R hold brake cables 130L, 130R under tension downstream, and the rudder pedals hold brake cables 130L, 130R under tension upstream. A pulley bracket 160 mounted to aircraft 110 comprises cable pulleys 161L, 161R, and cable pulleys 161L, 161R are configured to position brake cables 130L, 130R parallel to one another upstream of braking mechanism 250 and local to autoland braking system 100. Brake cables 130L, 130R are considered to run in a longitudinal direction with respect to aircraft 110, and subsequent references to a longitudinal direction (e.g. “longitudinal,” “longitudinally”) indicate this same direction unless otherwise noted, and items described as running, traveling, or similar in the longitudinal direction may be assumed to be parallel unless otherwise noted.

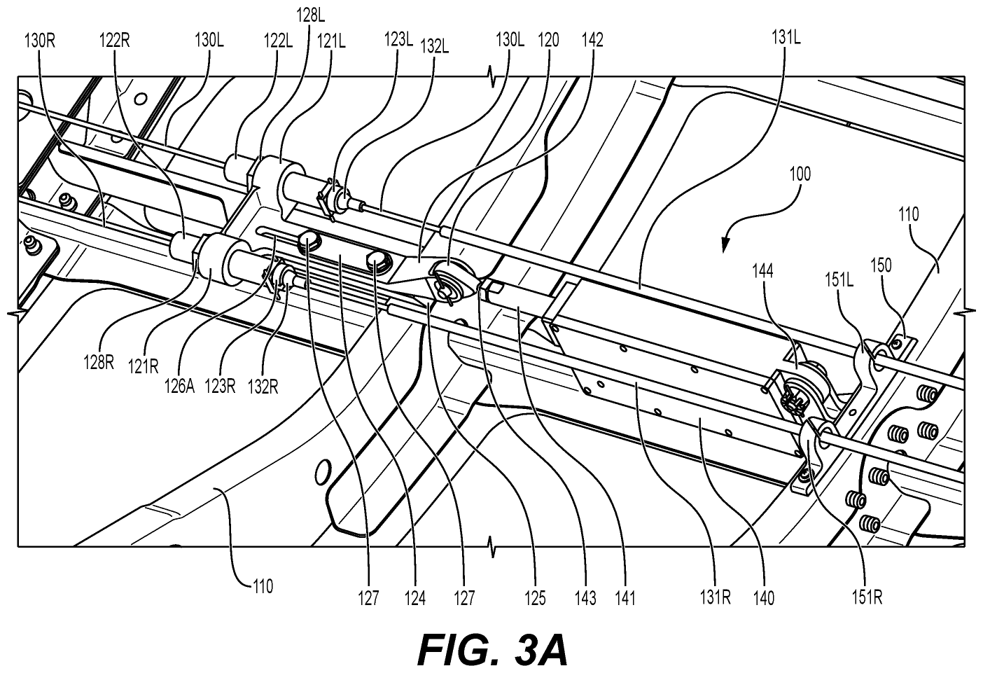

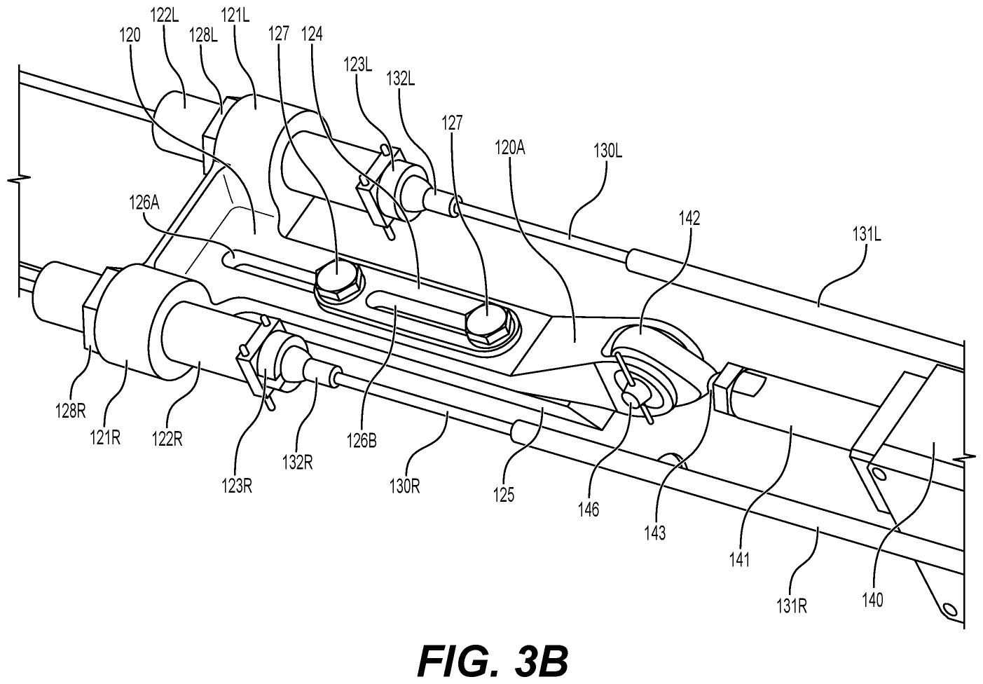

A plurality of fairlead brackets 150 receive brake cables 130 L, 130 R in the longitudinal direction such that brake cables 130L, 130R remain parallel in an area local to autoland braking system 100, particularly in a parallel region 180 shown in FIG. 1 near a slider 120 and an actuator 140, which autoland braking system 100 comprises and are further discussed in FIGS. 3A and 3B. Each fairlead bracket 150 comprises a pair of fairleads 151L, 151R, wherein each fairlead 151L, 151R comprises a ring which receives a brake cable. Fairlead bracket 150 may comprise a nylon or plastic component configured to house portions of brake cables 130L, 130R without causing wear of brake cables 130L, 130R and mounted to portions of aircraft 110 such as a frame, stringer, spar, or other structural component. Brake cables 130L, 130R may slide freely in a longitudinal direction through fairleads 151L, 151R, respectively. Left brake cable 130L runs through fairlead 151L and right brake cable 130R runs through fairlead 151R. The distance between fairleads 151L, 151R on each fairlead bracket 150 is the same, and each fairlead bracket 150 may be identical such that brake cables 130L, 130R remain longitudinal and parallel within a parallel region 180 between any two fairlead brackets 150 (i.e., in the area local to and adjacent the autoland braking system 100). In embodiments, a plurality of fairlead brackets 150 may be configured to fairlead brake cables 130L, 130R along the length of aircraft 110 such that brake cables 130L, 130R run in the longitudinal direction and remain substantially parallel adjacent to autoland braking system 100.

As seen in FIG. 2, a mechanical linkage 290 is configured to transmit force from brake cables 130L, 130R to braking mechanism 250. Specifically, tie members 210L, 210R are configured to hold the downstream ends of brake cables 130L, 130R respectively under tension. Tie members 210L, 210R are mechanically coupled to lever arms 220L, 220R on pivots 211L, 211R. Tie members 210L, 210R are free to rotate on pivots 211L, 211R. Lever arms 220L, 220R are rigidly fixed to extending members or other rotational means housed within shrouds 230L, 230R respectively such that arms 220L, 220R transmit torque to levers 240L, 240R. Levers 240L, 240R then act on components housed within mechanism 250. The specific action performed by levers 240L, 240R (e.g., a pull or rotation) may depend on the specific components configured within braking mechanism 250 to engage brakes of aircraft 110. For instance, levers 240L, 240R may be a part of a metering valve assembly, and a torque applied to lever arm 220L may engage a brake metering valve (not shown) within braking mechanism 250.

Brake mechanism 250 may comprise an electrohydraulic braking system wherein dual metering valves are configured to engage a left and right set of brakes respectively. A plurality of metering valves may also be used to engage a plurality of brakes, such as a set of front and rear brakes, or one or more master cylinders may be configured within braking mechanism 250 to engage the brakes when acted on by a torque.

Referring now to FIGS. 3A and 3B, autoland braking system 100 is mounted to the frame of aircraft 110 via fasteners such as screws, bolts, welds, or other mounting methods. FIG. 3A depicts portions of the frame of aircraft 110 to demonstrate a possible placement of autoland braking system 100 within an aircraft while all subsequent figures do not depict the frame of aircraft 110. Autoland braking system 100 comprises at least slider 120, brake cables 130L, 130R, and an actuator 140, and is suitable for engaging the brakes on aircraft 110 downstream of the brake rudder pedals, as further described below. Autoland braking system 100 is configured to provide emergency braking to an aircraft independent of pilot or copilot actuation of the rudder pedals. As depicted in FIG. 1, autoland braking system 100 is in a rest position with no emergency braking features active. When activated, actuator 140 pulls slider 120 longitudinally upstream.

Brake cables comprise cladding 131L, 131R and ball ends 132L and 132R. Cladding 131L, 131R comprises a stiffened portion of brake cables 130L, 130R configured to eliminate freeplay in the braking system under low tension. Furthermore, brake cables 130L, 130R are approximately parallel to one another near slider 120 and travel in the longitudinal direction. Ball ends 132L, 132R are components fixed to brake cables 130L, 130R that provide a region of locally increased diameter for brake cables 130L, 130R, such that a force can be applied to brake cables 130L, 130R in the longitudinal direction by pressing on ball ends 132L, 132R. For instance, ball ends 132L, 132R allow for a force to be applied parallel to the direction of brake cables 130L, 130R.

During normal aircraft operation with no emergency autoland activated, a pilot or copilot may depress the rudder brake pedals of aircraft 110 to engage the brakes. Force from the pedals is applied upstream of slider 120, such as by rudder pedals or toe brakes.

Slider 120 is configured as a rigging calibration mechanism that may apply a force to brake cables 130L, 130R when acted on by a single actuator, such as actuator 140. Slider 120 is secured relative to aircraft 110 by two-hole washer 124 and slide 125. Two-hole washer 124 comprises a plastic washer configured to accept two bolts that is bolted into slide 125 via shoulder bolts 127 with a shoulder bolt 127 slotted into each of slots 126a and 126b of slider 120, as seen most clearly in FIG. 3B. Slide 125 is a smooth surface configured to allow slider 120 to slide in a linear direction, particularly the longitudinal direction. Slots 126a and 126b are linear slots that permit slider 120 to move in the longitudinal direction. The use of two slots prevents the rotation of slider 120 around either shoulder bolt 127 and two-hole washer 124 constrains slider 120 such that slider 120 is constrained to move linearly in the longitudinal direction.

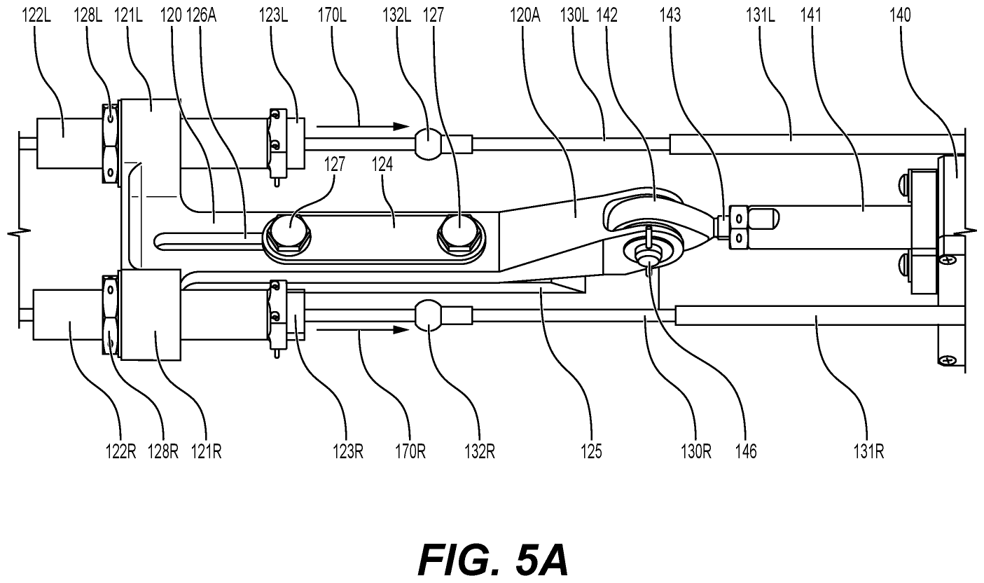

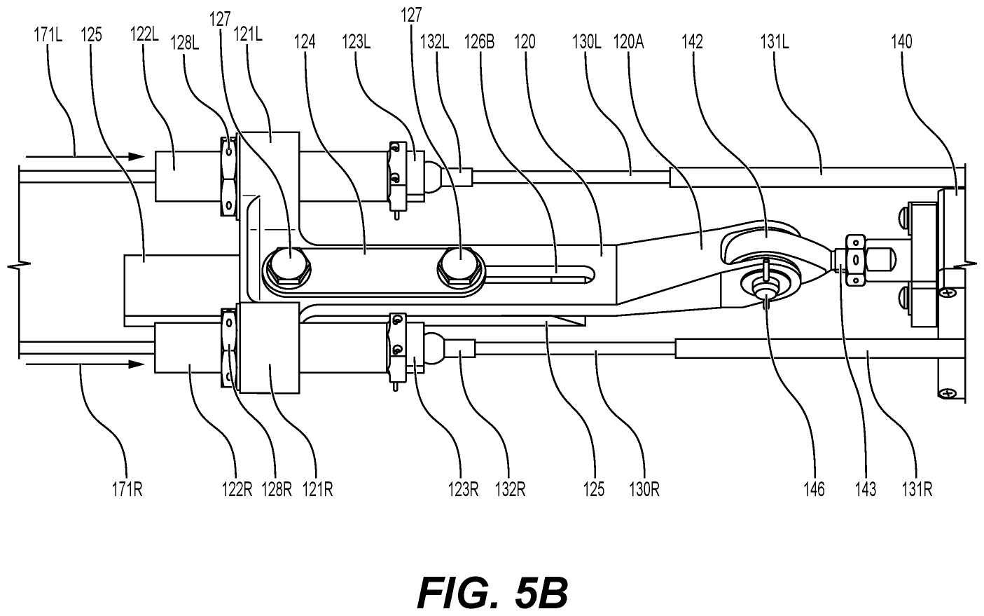

In a rest position, autoland braking system 100 is not engaged and does not cause braking. Slider 120 may contact components of brake cables 130L, 130R but does not supply an additional force to brake cables 130L, 130R beyond the resting tension of the system. Actuator 140 is not engaged and thus does not drive slider 120 in the rest position. Autoland braking system 100 is demonstrated in an engaged position in FIG. 5B.

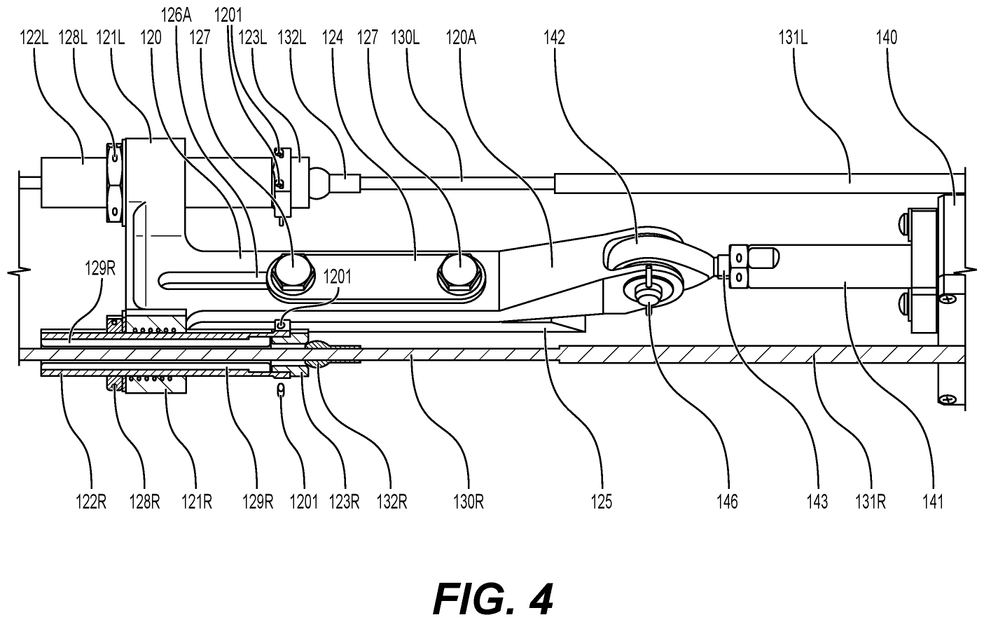

Slider 120 further comprises mounting loops 121L, 121R, adjustment tubes 122L, 122R, jam nuts 128L, 128R, and fairlead retainers 123L, 123R. Adjustment tube 122L is a hollow cylinder screwed into mounting loop 121L suitable for housing and enclosing a portion of brake cable 130L. In embodiments, adjustment tube 122L comprises external threading or another means of securing adjustment tube 122L within mounting loop 121L while allowing for the longitudinal position of adjustment tube 122L to be adjusted relative to slider 120. Jam nut 128L is configured to lock adjustment tube 122L in its position in the longitudinal direction, as further discussed in connection with FIG. 4. Adjustment tube 122L envelops brake cable 130L: one end of adjustment tube 122L is open such that brake cable 130L may pass through adjustment tube 122L. The other end comprises fairlead retainer 123 L, which in embodiments comprises two fairlead halves configured to allow brake cable 130L to pass through in the longitudinal direction. Fairlead retainer 123L contacts ball end 132L when the brakes are not depressed. Brake cable 130L runs longitudinally through adjustment tube 122L, and thus is partially encased by adjustment tube 122L.

In the rest position, ball end 132L rests against or sits next to fairlead retainer 123L. Thus, if slider 120 moves upstream, such as if driven by actuator 140, fairlead retainer 123L will press against ball end 132L. Because ball end 132L is not free to slide along brake cable 130L, brake cable 130 L will be pulled as slider 120 is pulled by actuator 140. Likewise, the same mechanism is used when fairlead retainer 123R presses against ball end 132R of brake cable 130R, and therefore the description is not repeated accordingly. Because the same mechanism applies to both brake cables 130L, 130R, and because slider 120 pushes the parallel brake cables in only the longitudinal direction, slider 120 uniformly displaces brake cables 130L, 130R.

When autoland braking system 100 is engaged, slider 120 will always impart an equal force on both brake cables 130L, 130R if neither brake cable is acted on by the rudder pedals. While balancing member applies a force to ball ends 132L, 132R, but upstream braking is not at a maximum, the brake pedals may still be depressed. Thus, because the rudder pedals may operate independently of autoland braking system 100, a pilot or copilot may provide additional braking to either brake cables 130L, 130R by depressing a pedal even if autoland braking system 100 is active. This requires a greater braking force from the toe brakes of the rudder pedals than from actuator 140 given that a braking force is already applied to brake cables 130L, 130R. This system allows for an uneven braking force to be applied to the brakes in the event that both autoland braking system 100 and the rudder pedals are engaged, as a single rudder pedal may engage only a single brake cable 130L, 130R even if autoland braking system 100 is active. Actuator 140 is operatively coupled to a nose 120A of slider 120 at a joint 143. Actuator 140 comprises an electromechanical actuator, a servo motor, a pushrod, or another device configured to apply mechanical force in the longitudinal direction. The power supplied to actuator 140 is such that the speed at which actuator 140 operates is controlled and may be a constant speed determined by a control system. In embodiments, a control system may send a discrete signal to actuator 140 such that actuator 140 is moved at a constant speed. In other embodiments, actuator 140 may be configured to operate at a variable speed, by a plurality of signals, or by a continuous signal. Autopilot or an emergency autoland control system on aircraft 110 may operate emergency autoland features on the aircraft, including but not limited to executing instructions to engage autoland braking system 100 with actuator 140 driven at a speed determined by the emergency autoland control system. This system may be implemented by a controller comprising software installed in a non-volatile memory of a computer on aircraft 110. In embodiments, the system may comprise a simple discrete signal or proportional command signal directed to actuator 140.

In simple discrete control, which may comprise an open-loop system, the controller supplies full power to actuator 140 via a simple discrete signal or otherwise to automatically engage an anti-skid mechanism configured on the brakes of aircraft 110. In this implementation, the braking force may be applied indefinitely or until the emergency autoland control system powers down.

For proportional control, the controller may apply a proportional braking force based on aircraft sensor readings for wheel speed, longitudinal acceleration, airspeed, altitude, or other data. The force applied by actuator 140 may be such that slider 120 engages braking mechanism 250 but does not cause lockup, skid, or a destabilization of aircraft 110. This control system would be implemented as a closed-loop system wherein feedback arises as the aircraft decelerates, leading to different conditions registered by aircraft sensors. In embodiments, an electrical signal of varying output may be sent to actuator 140 to produce a power output and level of actuation of corresponding varying output.

In embodiments, actuator 140 comprises a screw 146 which secures mounting loop 142 to joint 143. In the rest position, retractable portion 141 of actuator 140 is extended outward from actuator 140. When actuator 140 engages, actuator 140 pulls retractable portion 141 into actuator 140, thereby driving slider 120 longitudinally upstream and applying a force to brake cables 130L, 130R. Actuator 140 and retractable portion 141 are aligned along an axis parallel to brake cables 130L, 130R, such that the direction of the applied force is parallel to both brake cables 130L, 130R.

Actuator 140 is secured to aircraft 110 via a joint 144 and fairlead bracket 145. Joint 144 comprises a joint with a bolt or screw that permits actuator 140 to be mounted at an angle relative to aircraft 110 to conserve space. Fairlead bracket 145 comprises a metal support that secures actuator 140 relative to aircraft 110. Actuator 140 is mounted downstream of the rudder pedals such that autoland braking system 100 does not occupy space in the cockpit of aircraft 110.

FIG. 4 provides a cross-sectional view of adjustment tube 122R. Adjustment of adjustment tubes 122L, 122R allows for a rigging calibration of autoland braking system 100, wherein the displacement of brake cables 130L, 130R caused by autoland braking system 100 may be increased or decreased for each brake cable to produce an equal brake pressure or amount of braking supplied to each brake when brake cables 130L, 130R are displaced by autoland braking system 100. Within adjustment tube 122R, brake cable 130R runs parallel to slider 120. Ball end 132R of brake cable 130R rests against fairlead retainer 123R.

Fairlead retainer 123R may comprise aluminum or another durable material suitable for applying pressure to ball end 132R. Fairlead retainer 123R is secured to adjustment tube 122R by a plurality of cotter pins 1201, but in alternate embodiments may be secured to adjustment tube 122R by other means such as glue or a threaded coupling. Brake cable 130R is enveloped by fairlead halves 129R within adjustment tube 122L such that fairlead halves 129R provide a barrier between adjustment tube 122R and brake cable 130R. Fairlead halves 129R may comprise plastic, nylon, or another material suitable for preventing brake cable wear should brake cable 130R contact a fairlead half 129R. In embodiments, two or more fairlead halves 129R may be configured within adjustment tube 122R. Adjustment tube 122L comprises fairlead halves 129L (not shown), fairlead retainer 123R, and cotter pins 1201 configured in a similar manner and their description is not repeated accordingly.

Adjustment tube 122R comprises exterior threads configured to align with threading within mounting loop 121R to provide a threaded coupling. In embodiments, adjustment tube 122R may be repositioned by rotating adjustment tube 122R within mounting loop 121R such that fairlead retainer 123R at the end of adjustment tube 122R lies further forward or aft in the rest position. Once a desired position of adjustment tube 122R is reached, jam nut 128R may be screwed on adjustment tube 122R to lock adjustment tube 122R in place relative to slider 120.

The positioning of each adjustment tube 122L, 122R may comprise a calibration of autoland braking system 100, wherein autoland braking system 100 is calibrated to engage each brake by displacing brake cables 130L, 130R when actuator 140 applies a maximum force to slider 120. In embodiments, the position of the adjustment tubes 122L, 122R may be set to displace each of brake cables 130L, 130R equally such that a set of aircraft brakes are equally engaged for balanced braking. This may comprise an equal positioning of each adjustment tube 122L, 122R relative to slider 120. An asymmetrical positioning may be preferred to meet manufacturing tolerances in the cable assembly. For instance, in embodiments, in a default position, adjustment tube 122R is positioned as forward or upstream as possible relative to slider 120, and in this position, fairlead retainer 123R contacts ball end 132R. From this position, adjustment tube 122R may be moved aft or downstream relative to brake cable 130R and slider 120 by rotating adjustment tube 122R. This moves fairlead retainer 123R out of contact with ball end 132R, such that more displacement of slider 120 is required before autoland braking system 100 engages the brakes connected to brake cable 130R. When adjustment tube 122R is moved downstream, the magnitude of displacement imparted on brake cable 130R via pressure applied by fairlead retainer 123R is reduced given that fairlead retainer 123R remains static relative to slider 120 and slider 120 has a range of motion limited by contact between slots 126a, 126b and shoulder bolts 127. Adjustment tube 122R is therefore adjusted to calibrate a maximum displacement of brake cable 130L. Thus, autoland braking system 100 may be calibrated to apply less brake pressure to systems that require less brake pressure.

For calibrating displacement of brake cable 130L, adjustment tube 122L, mounting loop 121L, fairlead retainer 123L, and associated components are similarly arranged to their counterparts on left brake cable 130R, and their description is not repeated accordingly.

Autoland braking system 100 may also be configured on multiple aircraft without the introduction of new components or removal of preexisting ones: only the positions of adjustment tubes 122L or 122R need be adjusted to make the brake pressure supplied by autoland braking system 100 suitable for a given aircraft.

FIG. 5A depicts autoland braking system 100 when autoland braking system 100 is not engaged but brakes upstream of autoland braking system 100 (such as rudder pedals or toe brakes) are engaged. Brake cables 130L, 130R have been displaced upstream, as seen by the positions of ball ends 132L, 132R. Vectors 170L, 170R demonstrate the direction of the displacement.

FIG. 5B depicts autoland braking system 100 when autoland braking system 100 is engaged and supplies a greater braking force to the braking cables than any upstream braking subsystems. Slider 120 is displaced to a maximum degree (as limited by the length of slots 126a, 126b) by actuator 140, and the direction of the displacement is demonstrated by vectors 171L and 171R. Brake cables 130L, 130R have been displaced upstream as fairlead retainers 123L, 123R apply a force to ball ends 132L, 132R.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The invention claimed is:

1. An aircraft braking system, comprising:
a left brake cable operatively coupled to a braking mechanism and a left rudder pedal;
a right brake cable operatively coupled to the braking mechanism and a right rudder pedal;
a slider configured on a slide and mechanically coupled to the left brake cable and the right brake cable, wherein the slider is configured to displace the left and right brake cables when the slider is moved; and
an actuator configured to displace the slider, thereby activating the left and right braking mechanisms, respectively,
wherein the left and right rudder pedals are configured to displace their respective brake cables independently of the actuator and the slider.

2. The aircraft braking system of claim 1, comprising left and right adjustment members configured on the slider, wherein each adjustment member comprises a fairlead retainer configured to enclose a portion of each brake cable, and wherein each adjustment member may be adjusted in its position relative to the slider via external threading on each adjustment member configured to screw in threading configured on a portion of the slider.

3. The aircraft braking system of claim 2, wherein the left and right brake cables comprise a portion of increased local diameter fixed to the brake cable, and wherein the fairlead retainers of each adjustment member are configured to press against the portion of each brake cable when the slider is moved by the actuator.

4. The aircraft braking system of claim 3, comprising a jam nut configured on each adjustment member to lock each adjustment member in place after the adjustment member is adjusted.

5. The aircraft braking system of claim 4 comprising a parallel region of the left and right brake cables in which the left brake cable is substantially parallel with the right brake cable in a longitudinal direction.

6. The aircraft braking system of claim 5, comprising:
a first pair of fairleads having a left fairlead configured to receive the left brake cable and a right fairlead configured to receive the right brake cable, wherein the first pair of fairleads is mounted to an aircraft structure upstream of the slider;
a second pair of fairleads having a left fairlead configured to receive the left brake cable and a right fairlead configured to receive the right brake cable, wherein the second pair of fairleads is mounted to an aircraft structure downstream of the slider; and
an equal distance between the left and right fairleads for both the first pair and the second pair such that the left and right brake cables are substantially parallel to one another between the first and second pairs of fairleads, thereby forming the parallel region.

7. The aircraft braking system of claim 6, comprising two linear slots configured in the slider such that a bolt configured in each slot secures the slider to the slide.

8. The aircraft braking system of claim 7, wherein the linear slots run parallel to the longitudinal direction such the slider is constrained to move in a direction parallel to the longitudinal direction.

9. The aircraft braking system of claim 8, wherein the left and right adjustment members are calibrated such that an equal brake pressure is applied to a set of aircraft brakes when the actuator displaces the slider.

10. The aircraft braking system of claim 1, wherein the actuator is an electromechanical actuator configured to be powered to move at a constant speed.

11. An emergency autoland braking system for aircraft, comprising:
a pair of braking mechanisms;
a pair of brake cables operatively coupled to the pair of braking mechanisms, respectively;
a first braking subsystem configured to pull the pair of brake cables for activating the pair of braking mechanisms; and
a second braking subsystem configured to pull the pair of brake cables for activating the pair of braking mechanisms,
wherein the first and second braking subsystems operate independently of one another, and wherein the second braking system pulls the brake cables between the first braking subsystem and the pair of braking mechanisms.

12. The emergency autoland braking system of claim 11, wherein the first braking subsystem comprises a set of rudder pedals operatively coupled to the brake cables.

13. The emergency autoland braking system of claim 12, wherein the second braking subsystem comprises a slider operatively coupled to the pair of brake cables and configured to slide in a longitudinal direction such that an upstream force applied to the slider causes a displacement of each of the brake cables.

14. The emergency autoland braking system of claim 13, comprising a pair of mounting loops with adjustment tubes configured on the slider, wherein the adjustment tubes are configured to increase or decrease the displacement applied to each brake cable.

15. The emergency autoland braking system of claim 13, comprising an electric actuator configured to pull the slider for activating the pair of braking mechanisms.

16. The emergency autoland braking system of claim 13, comprising a plurality of fairleads configured to hold the pair of brake cables parallel to one another along the longitudinal direction in an area local to the second braking subsystem.

17. An emergency autoland braking system, comprising:
an actuator configured to displace a left and right brake cable when the actuator is driven, wherein displacement of the brake cables engages a set of aircraft brakes;
a calibration mechanism configured to adjust a magnitude of displacement of each brake cable when the actuator is driven; and
a control system configured to engage the actuator such that the set of aircraft brakes is engaged based on instructions provided by the control system.

18. The emergency autoland braking system of claim 17, comprising a controller configured to send an electrical signal to the actuator such that the actuator operates at a constant speed.

19. The emergency autoland braking system of claim 17, wherein the calibration mechanism comprises an adjustment tube configured to envelop each brake cable such that a position of each adjustment tube relative to each brake cable determines an amount of displacement provided to each brake cable when the actuator is engaged, thereby determining an amount of braking force provided to a respective aircraft brake.

20. The emergency autoland braking system of claim 19, comprising a fairlead retainer configured on each adjustment tube and a ball end configured on each brake cable such that each fairlead retainer contacts a respective ball end to displace the brake cable.
